(19) United States
(12) Patent Application Publication
(10) Pub. No.: US 2011/0198400 A1
(43) Pub. Date: Aug. 18, 2011

(54) CODE SYMBOL READING APPARATUS AND READING METHOD

(75) Inventor: Masahito Sano, Shizuoka (JP)

(73) Assignee: TOSHIBA TEC KABUSHIKI KAISHA, Tokyo (JP)

(21) Appl. No.: 13/020,036

(22) Filed: Feb. 3, 2011

(30) Foreign Application Priority Data
Feb. 15, 2010 (JP) 2010-030542

(51) Int. Cl. G06K 7/14

(52) U.S. Cl. 235/470

(57) ABSTRACT

According to one embodiment, a code symbol reading apparatus includes a scanner, a camera, a candidate area detection unit, a direction determination unit, and a direction notification unit. The candidate area detection unit detects an image area to be a candidate of the code symbol from an image of the image pickup area picked up by the camera. The direction determination unit determines such a direction that the image area to be the candidate of the code symbol overlaps the scanning area, when the code symbol cannot be read though the image area to be the candidate of the code symbol is detected by the candidate area detection unit. The direction notification unit notifies of the direction determined by the direction determination unit.

### CROSS-REFERENCE TO RELATED APPLICATION

This application is based upon and claims the benefit of priority from Japanese Patent Application No. 2010-030542, filed on Feb. 15, 2010, the entire contents of which are incorporated herein by reference.

### FIELD

Embodiments described herein relate generally to a code symbol reading apparatus which scans with a light beam and thus reads a code symbol such as a barcode attached to an article.

### BACKGROUND

There is a barcode reading apparatus which scans with a light beam and thus reads a barcode. Such a barcode reading apparatus has a camera with its focus position set in the scanning area of the light beam, and a monitor device for this camera. There also is a barcode reading apparatus provided with an indicator indicating the position of the scanning area on the display surface of the monitor device.

An operator who is familiar with the operation can adjust the direction and position of the barcode according to the indicator displayed on the monitor device and can securely place the barcode within the scanning area. However, an operator who is unfamiliar with the operation cannot determine which direction to move the, barcode in, even when seeing the indicator, and may take time for the adjustment.

### BRIEF DESCRIPTION OF THE DRAWINGS

FIG. 1 is a perspective view showing the appearance of a checkout terminal as an embodiment of the invention.

FIG. 2 is a block diagram showing the configuration of a barcode reading apparatus provided in the checkout terminal.

FIG. 3 is a flowchart showing processing procedures executed by a controller of the barcode reading apparatus according a control program.

FIG. 4 is a flowchart specifically showing procedures of guide message selection in FIG. 3.

FIG. 5 schematically shows the correspondence between a scanning area by a scanner and an image pickup area by a camera.

FIG. 6 shows the data configuration of a message table provided in the barcode reading apparatus.

FIG. 7 is a plan view showing an example of an article registration waiting screen displayed on a display device of the checkout terminal.

FIG. 8 is a plan view showing an exemplary display in an image display area when a barcode symbol is situated below the scanning area.

FIG. 9 is a plan view showing an exemplary display in the image display area when barcode data is not read though the barcode symbol is situated within the scanning area.

FIG. 10 is a plan view showing an exemplary display in the image display area when the barcode symbol is situated within the scanning area and barcode data is read.

### DETAILED DESCRIPTION

In general, according to one embodiment, a code symbol reading apparatus includes a scanner, a camera, a candidate area detection unit, a direction determination unit, and a direction notification unit. The scanner scans with a light beam and thus reads a code symbol. The camera picks up an image of an image pickup area that includes an entire scanning area of the light beam scanning a reading position of the code symbol and is broader than the scanning area. The candidate area detection unit detects an image area to be a candidate of the code symbol from an image of the image pickup area picked up by the camera. The direction determination unit determines such a direction that the image area to be the candidate of the code symbol overlaps the scanning area, when the code symbol cannot be read though the image area to be the candidate of the code symbol is detected by the candidate area detection unit. The direction notification unit notifies of the direction determined by the direction determination unit.

Hereinafter, an embodiment of the code symbol reading apparatus will be described using the drawings. In this embodiment, the code symbol reading apparatus is applied to a barcode reading apparatus 8 incorporated in a self-scanning type checkout terminal 1.

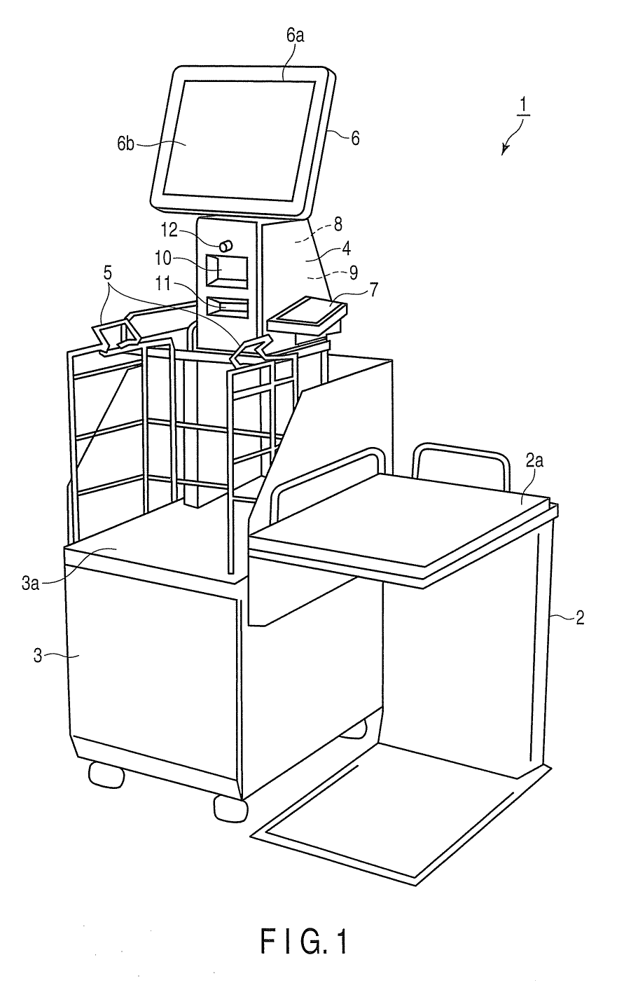

FIG. 1 is a perspective view showing the appearance of the checkout terminal 1. The checkout terminal 1 has an unregistered article placing table 2, a registered article placing table 3, and a terminal body 4. The unregistered article placing table 2 has a receiving surface 2a on which to place an article with unregistered article information. The registered article placing table 3 has a receiving surface 3a on which to place an article with already registered article information. The terminal body 4 is installed above the registered article placing table 3. A pair of hook parts 5 to hook the handle parts of a shopping bag is fixed on the receiving surface 3a of the registered article placing table 3.

A weight measuring unit to measure the weight of an article placed on the receiving surface 2a is provided on the receiving surface 2a of the unregistered article placing table 2. A weight measuring unit to measure the weight of an article placed on the receiving surface 3a is also provided on the receiving surface 3a of the registered article placing table 3. The weight measured by these weight measuring units is used for weight check in order to prevent failure to register an article or false registration.

A display device 6 is attached on top of the terminal body 4. The display device 6 is a cathode ray tube (CRT) display, liquid crystal display, organic electro-luminescence (organic EL) display or the like. A touch panel 6b is arranged on a screen 6a of the display device 6.

An electronic settlement terminal 7 is attached to a lateral side of the terminal body 4. The electronic settlement terminal 7 carries out wireless communication with an electronic money medium and performs electronic settlement of the price in a commercial transaction.

A barcode reading apparatus 8 and a receipt printer 9 are installed inside the terminal body 4. Also, a barcode reading window 10 and a receipt issue port 11 are formed on the front side of the terminal body 4. Moreover, a camera 12 formed by a CCD camera is attached above the barcode reading window 10 in the terminal body 4.

The barcode reading apparatus 8 reads a barcode symbol attached to an article held over a glass surface of the barcode reading window 10. The receipt printer 9 prints a receipt on which the content of a commercial transaction is recorded, and issues the receipt via the receipt issue port 11. The camera 12 picks up an image of an article held over the glass surface of the barcode reading window 10.

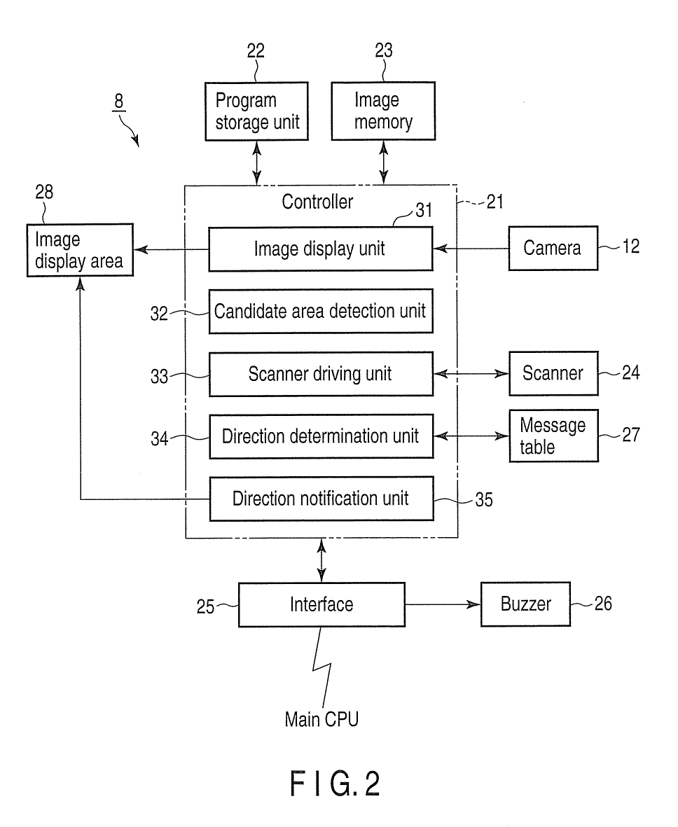

FIG. 2 is a block diagram showing the functional configuration of the barcode reading apparatus 8. The barcode reading apparatus 8 includes a controller 21, a program storage unit 22, a camera 12, an image memory 23, a scanner 24, an interface 25, a buzzer 26, a message table 27, and image display area 28.

The controller 21 servers as a control center of the barcode reading apparatus 8 and mainly include a central processing unit (CPU). The program storage unit 22 stores a control program to operate the controller 21.

The camera 12 includes a CCD image pickup element as an area image sensor, a driving circuit for the CCD image pickup element, and an image pickup lens to form an image in an image pickup area on the CCD image pickup element. The camera 12 outputs the image in the image pickup area formed on the CCD image pickup element through the image pickup lens, to the controller 21 on a frame basis. The image memory 23 sequentially unfolds and stores the frame image outputted from the camera 12.

The scanner 24 includes a light source, a rotating mirror, plural fixed mirrors, a light receiving element, and a signal processing unit. The light source emits a light beam. The rotating mirror reflects the light beam emitted from the light source. The fixed mirrors reflect the light beam reflected from the rotating mirror.

The plural light beams reflected from the fixed mirrors scan through the barcode reading window 10. In this case, if an article is held over the barcode reading window 10, a light beam is reflected on the surface of the article. The light receiving element receives reflected light from the article. The signal processing unit processes an electrical signal outputted from the light receiving element and thus reads the barcode attached to the article.

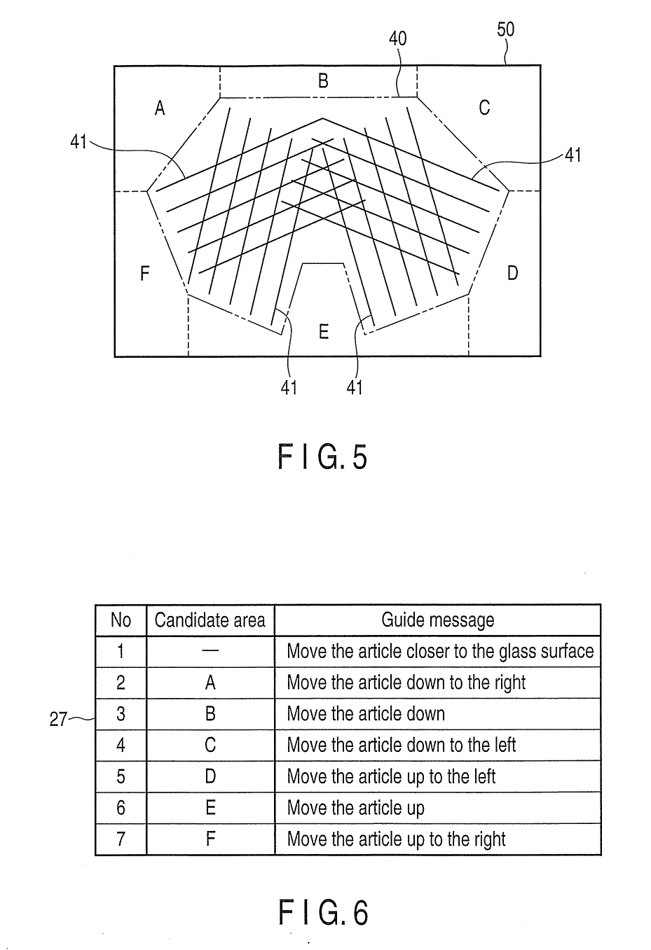

Here, the correspondence between the scanning area with the light beam and the image pickup area with the camera 12 will be described with reference to FIG. 5. In FIG. 5, an area 40 indicated by a double chain-dotted line is the scanning area with a light beam 41. An area 50 indicated by a solid line is the image pickup area with the camera 12. As shown in FIG. 5, the image pickup area 50 is broader than the scanning area 40 and includes the entire scanning area 40. That is, the camera 12 picks up the image of the image pickup area 50, which includes the entire scanning area 40 with the light beam 41 scanning the reading position of the barcode and is broader than the scanning area 40.

The interface 25 outputs the barcode data reads by the scanner 24 to a main CPU of the checkout terminal 1. The buzzer 26 outputs a predetermined reading completion sound in response to the output of the barcode data via the interface 25.

The message table 27 stores data of a guide message to the operator. The image display area 28 displays the frame image picked up by the camera 12, in real time.

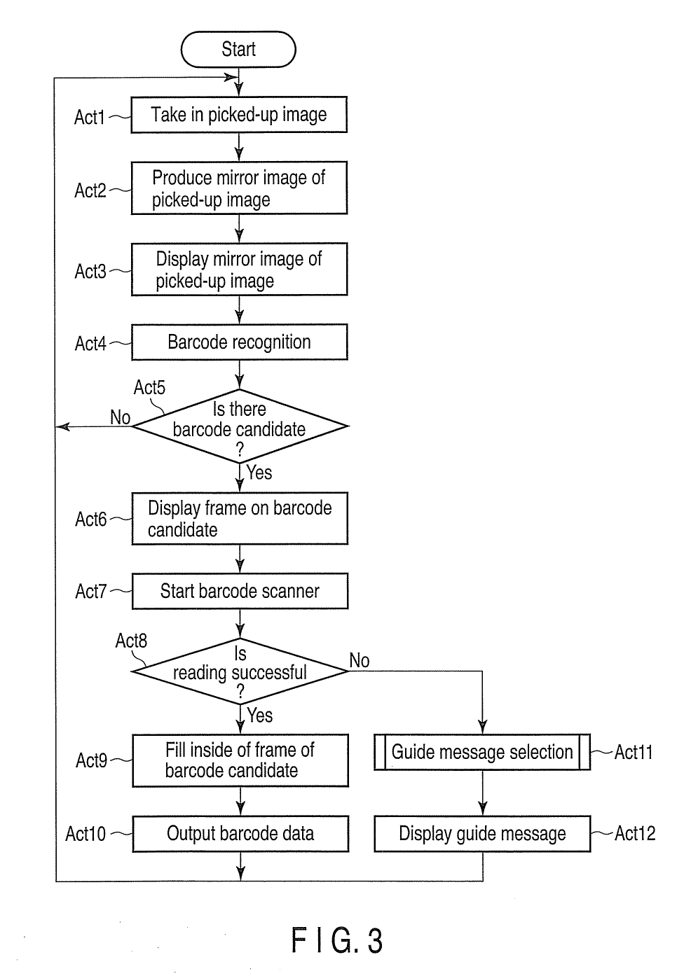

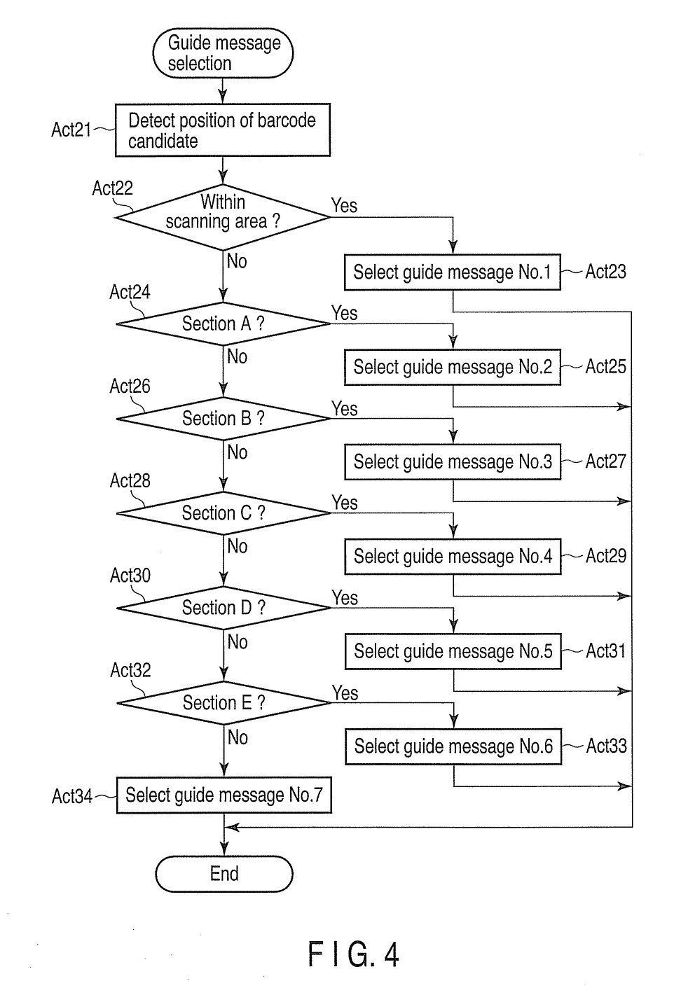

The controller 21 realizes the functions of an image display unit 31, a candidate area detection unit 32, a scanner driving unit 33, a direction determination unit 34 and a direction notification unit 35 according to the control program stored in the program storage unit 22. These functions will be described with reference to the flowcharts of FIG. 3 and FIG. 4.

As the control program is started, the controller 21 starts the processing shown in FIG. 3. First, the controller 21 takes in a frame image picked up by the camera 12 and unfolds this image in the image memory 23 (ACT 1). Next, the controller 21 produces data of a mirror image by reversing the picked up image in a left-right direction, based on the image data unfolded in the image memory 23 (ACT 2). After producing the mirror image, the controller 21 displays this mirror image in the image display area 28 (ACT 3).

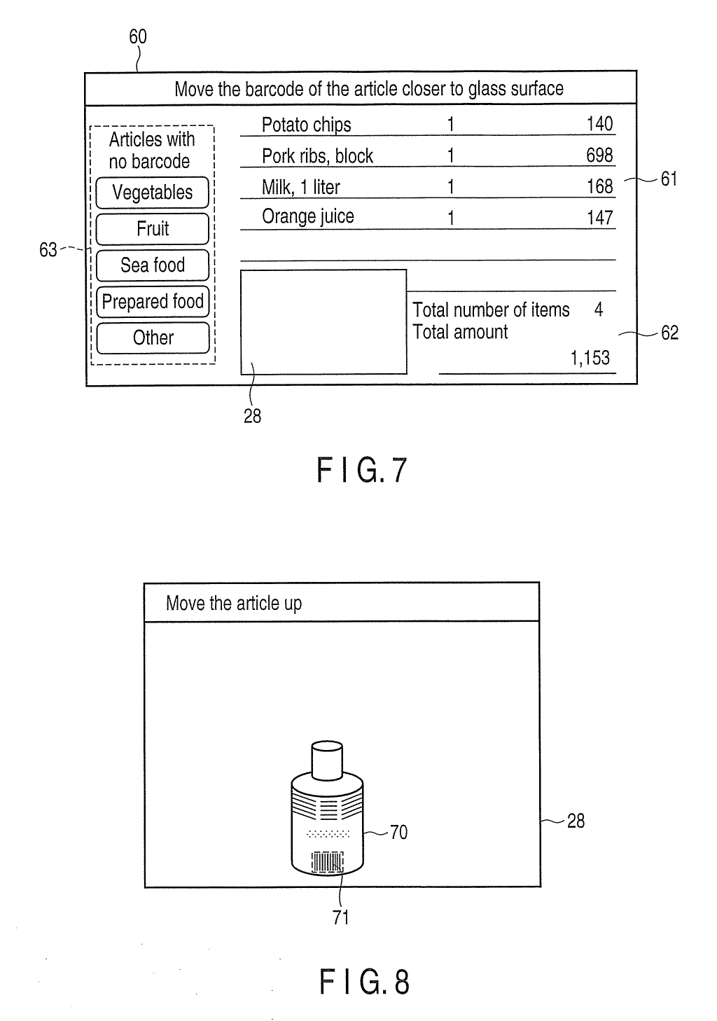

The image display area 28 is formed in a part of an article registration waiting screen 60 displayed on the display device 6 of the checkout terminal 1. FIG. 7 shows an example of the article registration waiting screen 60. In the checkout terminal 1, a details display section 61 for registered articles, a total display section 62 for registered articles, and a touch button area 63 showing the categories of articles with no barcode are arranged in the article registration waiting screen 60. In the barcode reading apparatus 8, the rectangular image display area 28 is formed at a bottom-center part of the article registration waiting screen 60. That is, in the barcode reading apparatus 8, the image display area 28 is formed substantially directly above the barcode reading window 10 formed on the front side of the terminal body 4.

Here, the image display unit 31 which displays the image picked up by the camera 12 on the display device 6 is realized by each processing of ACT 1, ACT 2 and ACT 3. The image displayed by the image display unit 31 is a mirror image acquired by reversing the image picked up by the camera 12 in the left-right direction.

Next, the controller 21 analyzes the frame image stored in the image memory 23 and detects an image area that is assumed to include a barcode symbol, that is, a so-called barcode candidate image area (ACT 4). This processing uses, for example, the technique disclosed in JP-A-2005-266907 laid public in Japan.

The controller 21 determines whether a barcode candidate image area is successfully detected or not (ACT 5). When a barcode candidate image area is not successfully detected (NO in ACT 5), the controller 21 returns to the processing of ACT 1. That is, the controller 21 takes in the next frame image from the camera 12 and executes each processing of ACTs 2, 3 and 4 again.

When a barcode candidate image area is successfully detected (YES in ACT 5), the controller 21 identifies and displays the barcode candidate image area from the image picked-up image displayed in the image display area 28. Specifically, the controller 21 encloses the barcode candidate image area with a frame (ACT 6).

When plural areas are simultaneously detected as barcode candidate image areas, the controller 21 decides priority of these areas as barcode candidates. The priority is decided based on a determination condition such as the proportion of the size of the barcode candidate image area to the flat area of the article, or the direction of the longitudinal side of the barcode candidate image area to the contour shape of the article. The controller 21 selects, identifies and displays the barcode candidate image area with the highest priority. That is, the controller 21 encloses the selected barcode candidate image area with a frame. Alternatively, the controller 21 encloses all the detected barcode candidate image areas with frames and changes the color of only the frame of the barcode candidate image area with the highest priority. The identification and display method is not limited to enclosing of the area with a frame.

Here, the candidate area detection unit 32 which detects an image area to be a candidate of a barcode from the image picked up by the camera 12 is realized by each processing of ACT 4, ACT 5 and ACT 6. The processing of ACT 6 can be omitted from the candidate area detection unit 32.

After identifying and displaying the barcode candidate image area, the controller 21 starts the scanner 24 (ACT 7). As the scanner 24 is started, a light beam emitted from the light source is emitted as scanning light through the barcode reading window 10. The scanning line is reflected on an object and its reflected light is received by the light receiving element. At this time, when the reflected light from the entire barcode symbol is received by the light receiving element, the scanner 24 can read the barcode data. However, when the reflected light can received only from a part of the barcode symbol or the reflected light from the barcode symbol cannot be received at all, the barcode data cannot be read. Here, the scanner driving unit 33 which scans with a light beam and thus reads a barcode is realized by the processing of ACT 7 on condition that a barcode candidate image area is detected.

The controller 21 determines whether the barcode data is successfully read by the scanner 24 (ACT 8). When the barcode data is successfully read (YES in ACT 8), the controller 21 fills the inside of the frame of the barcode candidate image area where the barcode data is successfully read, with a predetermined color (ACT 9). The controller 21 also outputs the barcode data read by the scanner 24 to the main CPU via the interface 25 (ACT 10). The main CPU performs registration of article information based on the barcode data inputted from the barcode reading apparatus 8.

Meanwhile, when the barcode data is not successfully read (NO in ACT 8), the controller 21 executes selection of a guide message (ACT 11). That is, the controller 21 determines such a direction that the barcode candidate image area overlaps the scanning area 40. The controller 21 then selects a guide message to guide the barcode candidate image area in the determined direction, from the message table 27. The controller 21 displays the selected guide message in the image display area 28 (ACT 12).

Here, the direction determination unit 34 which determines such a direction that the barcode candidate image area overlaps the scanning area 40 when the barcode cannot be read though the barcode candidate image area is detected, is realized by the processing of ACT 11. The direction notification unit 35 which notifies of the direction determined by the direction determination unit 34 is realized by the processing of ACT 12.

When the barcode data is outputted to the main CPU in the processing of ACT 10 or the guide message is displayed in the image display area 28 in the processing of ACT 12, the controller 21 returns to the processing of ACT 1. The controller 21 then takes in the next frame image from the camera 12 and executes the processing of ACT 2 and the subsequent processing again.

FIG. 4 is a flowchart showing specific procedures of the guide message selection (ACT 11). As the guide message selection is started, the controller 21 detects which position the barcode candidate image area exists in the picked-up image from the camera 12 (ACT 21). In this case, when there are plural barcode candidate image areas, the position of the barcode candidate image area with the highest priority is detected.

As shown in FIG. 5, in this embodiment, the area on the outer side of the scanning area 40, of the image pickup area 50, is divided into six sections A to F. According to the division, the barcode reading apparatus 8 has the message table 27 having the data content shown in FIG. 6.

That is, the message table 27 stores, as data of message number “1”, a guide message “Move the article closer to the glass surface” to guide the user to move the barcode closer to the glass surface of the barcode reading window 10. The message table 27 also stores, as data of message numbers “2” to “9”, guide messages “Move the article to XX (direction)” to guide the user to move each of the barcode candidate image areas situated in the sections A to F of the image pickup area 50 in such a direction that the barcode candidate image area overlaps the scanning area 40, together with the information of the corresponding sections A to F.

The controller 21 specifies the position of the barcode candidate image area in relation to the image pickup area 50. The position of the scanning area 40 in relation to the image pickup area 50 is specified in advance. The controller 21 compares the position of the barcode candidate image area with the position of the scanning area 40 in relation to the image pickup area 50. Then, based on the result of this comparison, the controller 21 determines whether the entire barcode candidate image area exists within the scanning area 40 or not (ACT 22).

When the entire barcode candidate image area exists within the scanning area 40 (YES in ACT 22), the barcode candidate image area is smaller than the scanning area 40 and therefore the barcode reading apparatus 8 cannot read the barcode data. In this case, the controller 21 specifies such a direction that the size of the barcode candidate image area becomes similar to the size of the scanning area 40, as such the direction that the barcode candidate image area overlaps the scanning area 40 (the direction determination unit 34). Then, the controller 21 selects the guide message data “Move the article closer to the glass surface” of message number “1” from the message table 27 (ACT 23).

Meanwhile, when at least a part of the barcode candidate image area is out of the scanning area 40 (NO in ACT 22), the controller 21 detects any one(s) of the sections A to F which a part of the barcode candidate image area overlaps. The position of each of the sections A to F in relation to the image pickup area 50 is specified in advance. The controller 21 compares the position of the barcode candidate image area with the position of each of the sections A to F in relation to the image pickup area 50. Then, based on the result of this comparison, the controller 21 detects the section which a part of the barcode candidate image area overlaps. At this time, when the barcode candidate image area overlaps plural sections, the controller 21 detects the section of the largest area.

When the section which the barcode candidate image area overlaps is detected, the controller 21 specifies such a direction that the barcode candidate image area in that section becomes closer to the center of the scanning area 40, as such the direction that the barcode candidate image area overlaps the scanning area 40 (the direction determination unit 34). Then, the controller 21 selects guide message data to instruct the user to move the article in this specified direction, from the message table 27.

That is, when the barcode candidate image area overlaps the section A (YES in ACT 24), the controller 21 selects the guide message data of message number “2” (ACT 25). When the barcode candidate image area overlaps the section B (YES in ACT 26), the controller 21 selects the guide message data of message number “3” (ACT 27). When the barcode candidate image area overlaps the section C (YES in ACT 28), the controller 21 selects the guide message data of message number “4” (ACT 29). When the barcode candidate image area overlaps the section D (YES in ACT 30), the controller 21 selects the guide message data of message number “5” (ACT 31). When the barcode candidate image area overlaps the section E (YES in ACT 32), the controller 21 selects the guide message data of message number “6” (ACT 33). When the barcode candidate image area overlaps the section F (NO in ACT 22 to ACT 32), the controller 21 selects the guide message data of message number “7” (ACT 34).

The one guide message thus selected is displayed in the image display area 28 by the processing of ACT 12. Then, the guide message selection ends.

The self-scanning type checkout terminal 1 having the barcode reading apparatus 8 of such configuration is installed, for example, at a checkout counter of a supermarket. A customer who carries out accounting of purchased articles using the checkout terminal 1 first places articles with unregistered article information on the receiving surface 2a of the unregistered article placing table 2. Next, the customer takes out the articles one by one from the receiving surface 2a and holds the barcode symbol attached to the articles over the barcode reading window 10.

When the barcode data is consequently read by the barcode reading apparatus 8, a reading completion sound is outputted from the buzzer 26. Also, the registration information of the articles is displayed in the details display section 61 of the article registration waiting screen 60 displayed on the display device 6. Then, the customer puts the articles which the customer holds in hand into a shopping bag spread on the receiving surface 3a of the registered article placing table 3.

Meanwhile, when the barcode data is not read even if the barcode symbol of the article is held over the barcode reading window 10, a mirror image of the picked-up image and a predetermined guide message are displayed in the image display area 28 of the article registration waiting screen 60.

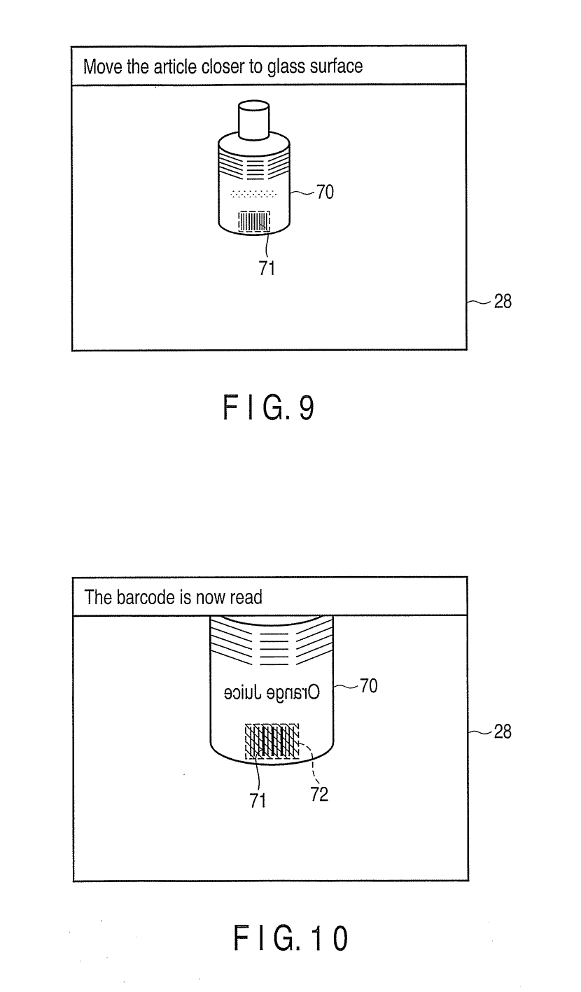

FIG. 8 shows an exemplary display in the image display area 28 where a guide message is displayed. For convenience of explanation, other images than the article are omitted. The same applies to FIG. 9 and FIG. 10, which will be described later.

In the example of FIG. 8, a barcode symbol 71 attached to an article 70 overlaps the section E in the bottom of the image pickup area 50. The area of the barcode symbol 71 does not overlap the scanning area 40. In this case, the guide message “Move the article up” of message number “6” is selected from the message table 27 and is displayed in the image display area 28. Thus, according to this message, the customer moves up the article 70 held over the barcode reading window 10.

FIG. 9 shows an exemplary display in the image display area 28 when the article 70 is moved up and the barcode symbol 71 is situated in the scanning area 40. In the example of FIG. 9, since the image of the barcode symbol 71 is small, the scanner 24 cannot read the barcode data. In this case, the guide message “Move the article closer to the glass surface” of message number “1” is selected from the message table 27 and displayed in the image display area 28. Thus, according to this message, the customer moves the article 70 held over the barcode reading window 10, closer to the glass surface.

FIG. 10 shows an exemplary display in the image display area 28 when the article 70 is moved closer to the glass surface. In the example of FIG. 10, since the article 70 is moved closer to the glass surface, the image of the barcode symbol 71 now appears larger. Therefore, the scanner 24 can read the barcode data. As the barcode data is read, the barcode candidate image area 72 is filled with a predetermined color. In the guide message section, a fixed message “The barcode is now read” is displayed.

Thus, the operator moving the article according to the guide message can recognize that the barcode data is read, as the barcode candidate image area 72 is filled with a predetermined color.

In this manner, simply by moving an article held over the barcode reading window 10 according to a guide message by the operator, the data of the barcode symbol attached to the article is securely read. Therefore, even when the operator is a customer who is unfamiliar with the operation of the self-scanning type checkout terminal 1, the operator can adjust the direction and position of the barcode symbol in a short time so that the barcode data can be securely read.

Moreover, a guide message is displayed on the display device 6 together with a picked-up image in the form of a mirror image in the image display area 28 provided substantially immediately above the barcode reading window 10. Therefore, the operation is easy since it suffices for the operator to move the article toward the center of the image display area 28 while viewing the picked-up image displayed in the image display area 28. Thus, the time required for reading the barcode data can be reduced and processing efficiency can be improved. Moreover, stress on the operator can be reduced, too.

The barcode reading apparatus 8 starts the scanner 24 to read barcode data on condition that a barcode candidate image area is detected. Therefore, since the scanner 24 operates only when a barcode is held over the barcode reading window 10, there also is an advantage that unnecessary emission of light beams can be prevented.

The invention is not limited to the embodiment. In practical implementations, components can be embodied in modified manners without departing from the scope of the invention.

For example, in the embodiment, the direction notification unit 35 displays a guide message and thereby notifies of such the direction that the image area to be a candidate of a code symbol overlaps the scanning area. However, the direction notification unit 35 is not limited to this example. For example, the direction notification unit 35 may notify of a guide message via an audio guide using a voice synthesizer. In this case, the image display unit 31 which displays an image picked up by the camera 12 on the display device 6 is not necessarily required.

In the embodiment, the invention is applied to the barcode reading apparatus 8 in the self-scanning type checkout terminal 1. However, the application target of the invention is not limited to this example. The invention can also be applied to a reading apparatus for other code symbols than barcodes, for example, two-dimensional data codes.

The barcode reading apparatus 8 in the embodiment starts the scanner 24 on condition that a barcode candidate image area is detected. The barcode reading apparatus 8 may also start the scanner in advance irrespective of whether a barcode candidate image area is detected or not.

Moreover, in the embodiment, it is assumed that the control program to realize the functions of the invention is recorded in advance in the program storage unit 22 within the apparatus. However, without being limited to this example, a similar program may be downloaded to the apparatus from a network. Alternatively, a similar program recorded in a recording medium may be installed in the apparatus. The recording medium may be of any form as long as the recording medium can store a program and can be read by the apparatus, like CD-ROM. The functions that can be acquired by installation or download of the program may also be realized in cooperation with the operating system (OS) within the apparatus or the like.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A code symbol reading apparatus comprising:
a scanner which scans with a light beam and thus reads a code symbol;
a camera which picks up an image of an image pickup area that includes an entire scanning area of the light beam scanning a reading position of the code symbol and is broader than the scanning area;
a candidate area detection unit which detects an image area to be a candidate of the code symbol from an image of the image pickup area picked up by the camera;
a direction determination unit which determines such a direction that the image area to be the candidate of the code symbol overlaps the scanning area, when the code symbol cannot be read though the image area to be the candidate of the code symbol is detected by the candidate area detection unit; and
a direction notification unit which notifies of the direction determined by the direction determination unit.

2. The apparatus of claim 1, wherein the direction determination unit specifies such a direction that a size of the image area detected by the candidate area detection unit grows, as such the direction that the image area to be the candidate of the code symbol overlaps the scanning area.

3. The apparatus of claim 1, wherein the direction determination unit specifies such a direction that the image area detected by the candidate area detection unit becomes closer to a center of the scanning area, as such the direction that the image area to be the candidate of the code symbol overlaps the scanning area.

4. The apparatus of claim 1, further comprising an image display unit which displays the image picked up by the camera in a display area,
wherein when the image area to be the candidate of the code symbol is detected by the candidate area detection unit, the image display unit identifies and displays this image area on the image picked up by the camera in the display area.

5. The apparatus of claim 4, wherein the direction determination unit specifies such a direction that a size of the image area detected by the candidate area detection unit grows, as such the direction that the image area to be the candidate of the code symbol overlaps the scanning area.

6. The apparatus of claim 4, wherein the direction determination unit specifies such a direction that the image area detected by the candidate area detection unit becomes closer to a center of the scanning area, as such the direction that the image area to be the candidate of the code symbol overlaps the scanning area.

7. The apparatus of claim 4, wherein the direction notification unit displays a guide message to notify of the direction determined by the direction determination unit, in the display area.

8. The apparatus of claim 4, wherein the image display unit displays a mirror image acquired by reversing the image picked up by the camera in a left-right direction, in the display area.

9. The apparatus of claim 8, wherein the direction determination unit specifies such a direction that the image area detected by the candidate area detection unit becomes closer to a center of the scanning area, as such the direction that the image area to be the candidate of the code symbol overlaps the scanning area.

10. The apparatus of claim 1, further comprising a scanner driving unit which drives the scanner on condition that the image area to be the candidate of the code symbol is detected by the candidate area detection unit.

11. The apparatus of claim 4, wherein when plural image areas to be candidates of the code symbol are detected by the candidate area detection unit, the image display unit selects one of the image areas and identifies and displays the selected image area on the image picked up by the camera, and
the, direction determination unit specifies such a direction that a size of the image area selected from the plural image areas grows, as such the direction that the image area to be the candidate of the code symbol overlaps the scanning area.

12. The apparatus of claim 4, wherein when plural image areas to be candidates of the code symbol are detected by the candidate area detection unit, the image display unit selects one of the image areas and identifies and displays the selected image area on the image picked up by the camera, and
the direction determination unit specifies such a direction that the image area selected from the plural image areas becomes closer to a center of the scanning area, as such the direction that the image area to be the candidate of the code symbol overlaps the scanning area.

13. A code symbol reading method comprising;
scanning with a light beam from a scanner and thus reading a code symbol;
picking up, by a camera, an image of an image pickup area that includes an entire scanning area of the light beam scanning a reading position of the code symbol and is broader than the scanning area;
detecting an image area to be a candidate of the code symbol from an image of the image pickup area picked up by the camera;
determining such a direction that the image area to be the candidate of the code symbol overlaps the scanning area, when the code symbol cannot be read though the image area to be the candidate of the code symbol is detected; and
notifying of the determined direction.
